(19) United States
(12) Patent Application Publication
(10) Pub. No.: US 2023/0035005 A1
(43) Pub. Date: Feb. 2, 2023

(54) Guide rail connecting device for pickup truck bed cover

(71) Applicant: Ningbo Crosstrip Electronic Science Co.,Ltd, Cixi City (CN)

(72) Inventors: Lei Chen, Cixi City (CN); Yong Li, Cixi City (CN)

(21) Appl. No.: 17/391,059

(22) Filed: Aug. 2, 2021

(51) Int. Cl. B60J 7/02

(52) U.S. Cl. CPC B60J 7/02

(57) ABSTRACT

A guide rail connecting device for pickup truck bed cover is provided, which includes a guide rail connecting device body, the body includes a first connecting block and a second connecting block, the first connecting block is arranged outside the guide rail, the second connecting block extends into the guide rail, the first connecting block is connected with the second connecting block, the body is connected with a supporting part for supporting the guide rail. In the invention, the guide rail is clamped and connected through the use of the first connecting block and the second connecting block, the support part is used to apply an upward prestress to the guide rails to support the guide rail and prevent the guide rail from collapsing and deforming at the connection.

### TECHNICAL FIELD

This invention is relevant, to guide rail connecting device field, especially about the guide rail connecting device for pickup truck bed cover.

### BACKGROUND

With the development, of pick-up trucks, more pick-up trucks began to install bed covers. When some car cover are used, guide rails need to be installed inside the pick-up trucks. However, because the guide rails are too long, they are not only easy to be damaged in the actual transportation process, but also the transportation cost is too high. Therefore, the current method is to divide the guide rail into two sections for transportation, and then splice the two sections of guide rail to form a guide rail while using.

The biggest problem in this way is the connection of the two guide rails, the existing methods directly connected the two guide rails on the sides through the connecting block, the connection between the two sections is easy to collapse after long time use.

### SUMMARY

The purpose of the invention is to provide a pickup truck bed cover guide rail connection device. By adding an upward preload to the rail, make the guide rail connection not easy to collapse and prolong the service life of the guide rail.

Method used in the invention is as follows:

The guide rail connecting device includes a guide rail connecting device body, the body includes a first connecting block and a second connecting block, the first connecting block is arranged outside the guide rail, the second connecting block extends into the guide rail, the first connecting block is connected with the second connecting block, the body is connected with a supporting part for supporting the guide rail.

The guide rail is clamped and connected through the first connecting block, and the second connecting block, then an upward prestress is applied to the guide rail by the support part to support the guide rail and prevent the guide rail from collapsing and deforming at the connection.

When in use, the second connecting block is first put into the guide rail from the end of the the guide rail, then the second connecting block is placed at the connection of two guide rails, and then the first connecting block is connected with the second connecting block, the two connecting blocks clamp the ends of the two guide rails to form a complete guide rail, finally connect the support part to apply an upward prestress on the guide rail to prevent collapse at the connection of the guide rail.

Furthermore, the first connecting block and the second connecting block are connected by connecting screws, Using a connecting screw to connect the first connecting block and the second connecting block, not only facilitates the disassembly, but also improves the stability, the support part is a coping correction screw, the first connecting block includes a supporting plate and a connecting plate, the connecting plate is used for connecting with the second connecting block, the support plate is used for connecting with the coping correction screw, screw the coping correction screw onto the support plate until the coping correction screw presses the guide rail tightly while connecting.

Furthermore, the support plate and the connecting plate are perpendicular to each other, the support plate is set horizontally while the connecting plate is set vertically in actual use, the first connecting block adopts the structure of two plates, one of which is used to cooperate with the second connecting block to clamp the guide rail, the other is used to connect the support part to support the guide rail, the first connecting block is an integrated structure, the integrated structure design of the first connecting block greatly improve overall mechanical performance of the first connecting block.

Furthermore, the first connecting block is provided with a connecting groove, the second connecting block is provided with a convex block, which can match the connecting groove, one side of the guide rail is provided with an opening slot, the convex block passes through the opening slot and connects with the first connecting block. By setting the connecting groove and the convex block, the connecting groove and the convex block are clamped when connecting to greatly improve the installation accuracy of the first connecting block and the second connecting block.

Furthermore, the first connecting block is provided with a plurality of first connecting screw holes, the second connecting block is provided with a plurality of second connecting screw holes, the first connecting screw holes and the second connecting screw holes are correspondingly arranged one by one, the connecting screw passes through the first connecting screw hole and the second connecting screw hole and connects with the first connecting block and the second connecting block. By setting the first connecting screw hole and the second connecting screw hole, the two connecting holes are connected by the connecting screw, different number of the first, connecting screw holes and the second connecting screw holes can be drilled according to actual demand, the first connecting screw holes are arranged in the connecting groove, and the second connecting screw holes are arranged on the convex block, the first connecting screw holes are arranged in the connecting groove so that when the first connecting block and the second connecting block are connected, the guide rail is clamped from both sides to ensure the stability of the guide rail connection, the coping correction screw is provided with a plurality of screws, and the coping correction screw is provided with at least two screws, the two coping correction screws respectively support the guide rail when connecting to ensure the stress intensity at the connection of the guide rail, the support plate is provided with coping screw holes, the coping correction screws are connected to the coping screw holes and butted against the bottom of the guide rail, the coping screw holes are designed according to actual demand, or more holes can be made as reserved holes, the guide rail is connected to the inner side of the pickup truck rear bucket.

The beneficial of the invention as follows:

In the invention, the guide rail is clamped and connected through the first connecting block and the second connecting block, then an upward prestress is applied to the guide rails by the support part to support the guide rail and prevent the guide rail from collapsing and deforming at the connection.

2. In the invention, the first connecting block adopts the structure of two plates, one of which is used to cooperate with the second connecting block to clamp the guide rail, the other is used to connect the support part to support the guide rail, the first connecting block is an integrated structure, the integrated structure design of the first connecting block greatly improve overall mechanical performance of the first connecting block.

3. By setting the connecting groove and the convex block, the connecting groove and the convex block are clamped when connecting to greatly improve the installation accuracy of the first connecting block and the second connecting block.

### DESCRIPTION OF DRAWINGS

FIG. 1 is a structure illustration of the invention;

FIG. 2 is a side view of the invention;

FIG. 3 is an application Illustration of the invention

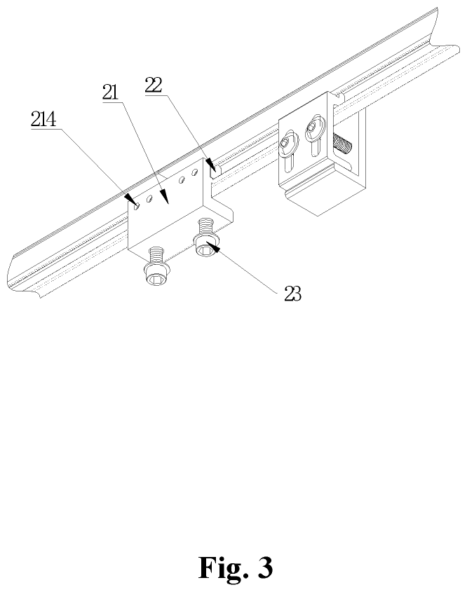

FIG. 4 is an exploded view of the invention;

FIG. 5 is a loading diagram of the guide rail connecting block of the invention.

1—Guide rail; 11—Opening slot; 2—Connecting device body; 21—First connecting block; 211—Supporting plate; 212—Connecting plate; 213—Connecting groove; 214—First connecting screw hole 2; 215—Coping screw hole; 22—Second connecting block; 221—Convex block; 222—Second connecting screw hole; 23—Coping correction screw; 24—Connecting screw; 3—Pickup truck rear bucket.

### The Concrete Method to Carry Out

The following instruction is to further explain the concrete implementation method in the invention with the drawings and specific examples. It needs to be explained that although the instructions of these embodiments are used to help understand the invention, they do not constitute a restriction on the invention. The functional details disclosed herein are used only for example embodiments of the invention. However, the invention can be embodied in many alternative forms and should not be limited to the embodiments described herein.

It should be understood that the terms used in the invention are used only to describe specific embodiments and do not intend to restrict the example embodiments of the invention. For example, when the terms “include”, “included”, “include” or “included” are used in the invention, only the existence of features, integers, steps, operations, units or components in this claim is specified, the existence or addition of one or more other features, quantities, steps, operations, units, components and their combinations is not excluded.

It should also be noted that in some example embodiments, the functions or actions may be different from the order appearing in the accompanying drawings. For example, depending on the function or action involved, it can actually be executed in real concurrency, or sometimes in reverse order to perform two consecutive diagrams.

The specific details provided in the following description are to facilitate a complete understanding of the example embodiments. However, those of ordinary skill in the art will appreciate that the example embodiments can be implemented without these specific details. For example, the system may be shown in the block diagram to avoid obscuring the example with unnecessary details. In other cases, as everyone knows, no well-known details can be drawn to show the well-known process, structure and technology, so as to avoid making the example examples unclear.

Method 1:

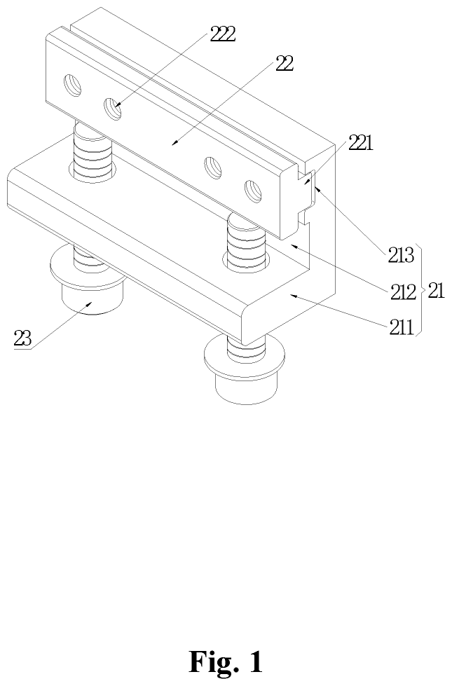

As is seen from FIG. 1, the guide rail connecting device includes a guide rail connecting device body2, the body2 includes a first connecting block21 and a second connecting block22, the first connecting block21 is arranged outside the guide rail1, the second connecting block22 extends into the guide rail1, the first connecting block21 is connected with the second connecting block22, the body2 is connected with a supporting part for supporting the guide rail1.

The guide rail is clamped and connected through the first connecting block21 and the second connecting block22, then an upward prestress is applied to the guide rail1 by the support part to support the guide rail1 and prevent the guide rail1 from collapsing and deforming at the connection.

When in use, the second connecting block22 is first put into the guide rail1 from the end of the guide rail1, then the second connecting block22 is placed at the connection of two guide rail1, and then the first connecting block21 is connected with the second connecting block22, the two connecting, blocks clamp the ends of the two guide rails1 to form a complete guide rail1, finally the support part is connected to apply an upward prestress on the guide rail1 to prevent collapse at the connection of the guide rail1.

Method 2:

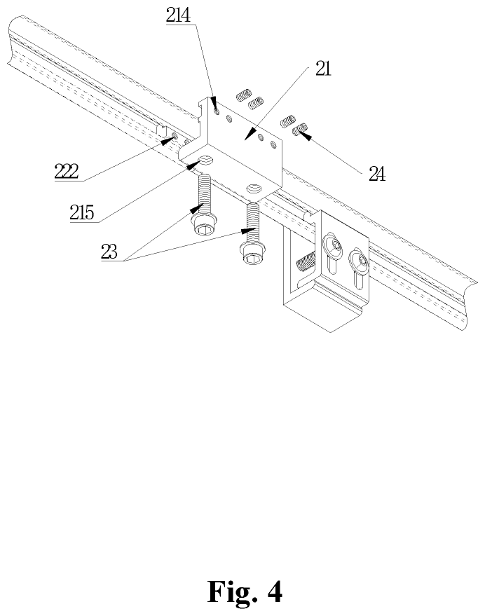

On the basis of method 1, as shown in FIG. 4, the first connecting block21 and the second connecting block22 are connected by connecting screws24.

Using a connecting screw24 to connect the first connecting block21 and the second connecting block22 not only facilitates the disassembly, but also improves the stability.

The support part is a coping correction screw23,

The first connecting block21 includes a supporting plate211 and a connecting plate212, the connecting plate212 is used for connecting with the second connecting block22, the support plate211 is used for connecting with the coping correction screw23.

While connecting, screw the coping correction screw23 onto the support plate211 until the coping correction screw23 presses the guide rail1 tightly.

Method 3:

On the basis of method 2, the support plate211 and the connecting plate212 are perpendicular to each other.

In actual use, the support plate211 is set horizontally while the connecting plate212 is set vertically.

The first connecting block21 adopts the structure of two plates, one of which is used to cooperate with the second connecting block22 to clamp the guide rail1 the other is used to connect the support part to support the guide rail1.

The first connecting block21 is an integrated structure.

The integrated structure design of the first connecting block21 greatly improve the overall stress performance of the first connecting block21.

Method 4:

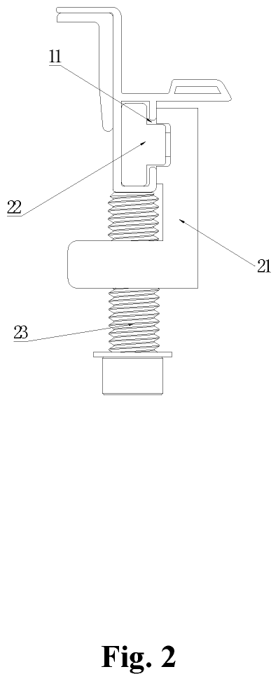

On the basis of method 3, as shown in FIGS. 2 &3, the first connecting block21 is provided with a connecting groove213, the second connecting block22 is provided with a convex block221 which can match the connecting groove213.

One side of the guide rail1 is provided with an opening slot11, the convex block221 passes through the opening slot11 and connects with the first connecting block21.

By setting the connecting groove213 and the convex block221, the connecting groove213 and the convex block221 are clamped when connecting to greatly improve the installation accuracy of the first connecting block21 and the second connecting block22.

Method 5:

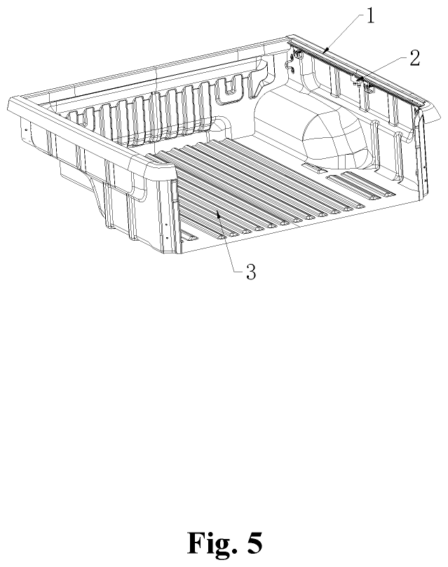

On the basis of method 4, as shown in, FIG. 5, the first connecting block2l is provided with a plurality of first connecting screw holes214, the second connecting block22 is provided with a plurality of second connecting screw holes222, the first connecting screw holes214 and the second connecting screw holes222 are correspondingly arranged one by one, the connecting screw24 passes through the first connecting screw hole214 and the second connecting screw hole222 and connects with the first connecting block21 and the second connecting block22.

By setting the first connecting screw hole214 and the second connecting screw hole222, the two connecting holes are connected by the connecting screw24, different number of the first connecting screw holes214 and the second connecting screw holes222 can be chilled according to actual demand.

The first connecting screw holes214 are arranged in the connecting groove213, and the second connecting screw holes are arranged on the convex block221.

The first connecting screw holes214 are arranged in the connecting groove213 so that when the first connecting block21 and the second connecting block22 are connected, the guide rail1 is clamped from both sides to ensure the stability of the guide rail1 connection.

The supporting part is a coping correction screw23.

The coping correction screw23 is provided with a plurality of screws.

The coping correction screw23 is provided with at least two screws, the two coping correction screws respectively support the guide rail1 when connecting to ensure the stress intensity at the connection of the guide rail1

The support plate211 is provided with coping screw holes215, the coping correction screws23 are connected to the coping screw holes215 and butted against the bottom of the guide rail1.

The coping screw holes215 can be drilled according to actual demand, or more holes can be made as reserved holes.

The guide rail1 is connected to the inner side of the pickup truck rear bucket3.

### Detail Working Principle:

Installation method: first, put the second connecting blockd22 into two guide rail1 from the end of the two guide rails1, then place the second connecting blockd22 at the connection of the two guide rails1, and then connect the first connecting blockd21 and the second connecting blockd22 by connecting screws24, the two connecting blocks clamp the ends of the two guide rails1 to fault a complete guide rail1, finally fasten the coping correction screw23 on the support plate to apply an upward prestress on the guide rail1 to prevent collapse at the connection of the guide rail.

Above embodiment only illustrates the technical proposal of the invention, rather than restricting it. Although the present invention has been described in detail with reference to the above mentioned embodiment, for those skilled in the art, it can still modify the technical solutions recorded in the above mentioned embodiment, or replace some of the technical features of the same. Any modification, equivalent replacement, improvement, etc. made within the spirit and principle of the invention shall be included in the scope of protection of the invention.

The invention is not limited to the above optional embodiments, anyone can obtain various other forms of products under the Enlightenment of the invention. Above specific embodiments should not be understood as limiting the scope of protection of the invention. The scope of protection of the invention should be defined in the claims, and the description can be used to interpret the claims.

1. The guide rail connecting device includes a guide rail connecting device body (2), the body (2) includes a first connecting block (21) and a second connecting block (22), the first connecting block (21) is arranged outside the guide rail (1), the second connecting block (22) extends into the guide rail (1), the first connecting block (21) is connected with the second connecting block (22), the body (2) is connected with a supporting part for supporting the guide rail (1).

2. A guide rail connecting device according to claim 1, wherein, the first connecting block (21) is provided with a connecting groove (213), the second connecting block (22) is provided with a convex block(221) which can match the connecting groove (213).

3. A guide rail connecting device according to claim 2, wherein one side of the guide rail (1) is provided with an, opening slot (11), the convex block (221) passes through the opening slot (11) and connects with the first connecting block (21).

4. A guide rail connecting device according to claim 1, wherein the first connecting block (21) includes a supporting plate (211) and a connecting plate (212), the connecting plate (212) is used for connecting with the second connecting block (22), the support plate (211) is used for connecting with the connecting plate.

5. A guide rail connecting device according to claim 4, wherein the support plate (211) and the connecting plate (212) are perpendicular to each other.

6. A guide rail connecting device according to claim 4, wherein the first connecting block (21) is an integrated structure.

7. A guide rail connecting device according to claim 1, wherein the supporting part is a coping correction screw (23), the coping correction screw(23) is provided with at least two screws.

8. A guide rail connecting device according to claim 2, wherein the first
connecting block (21) and the second connecting block (22) are connected by connecting screws (24).

9. A guide rail connecting device according to claim 8, wherein the first connecting block (21) is provided with a plurality of first connecting screw holes (214), the second connecting block (22) is provided with a plurality of second connecting screw holes (222), the first connecting screw holes (214) and the second connecting screw holes (222) are correspondingly arranged one by one, the connecting screw (24) passes through the first connecting screw hole (214) and the second connecting screw hole (222) and connects with the first, connecting block (21) and the second connecting block (22).

10. A guide rail connecting device according to claim 8, wherein the first, connecting screw hole (214) is arranged in the connecting groove(213), the second connecting screw hole (222) is arranged on the convex block (221).
